(19) United States
(12) Patent Application Publication
(10) Pub. No.: US 2011/0074145 A1
(43) Pub. Date: Mar. 31, 2011

(54) Connecting Device for Fluid Mediums

(76) Inventors: Otfried Schwarzkopf, Kuerten (DE); Lechner Martin, Lindlar (DE)

(21) Appl. No.: 12/599,643

(22) PCT Filed: Apr. 22, 2008
(86) PCT No.: PCT/EP08/54853

§ 371 Date: Nov. 10, 2009

(30) Foreign Application Priority Data
May 11, 2007 (DE) 20 2007 006 954.5

(51) Int. Cl. F16L 47/02

(52) U.S. Cl. 285/21.2

(57) ABSTRACT

The present invention relates to a connecting device (1) for fluid mediums, in particular hydraulic fluid mediums, consisting of a plastic connecting element (2) having at least one connecting section (4) with a receiving opening (6) for a tubular conduit end (8) to be laser-welded. The connecting element (2) consists of at least two components (K1, K2) with different material properties, a first component (K1) surrounding the receiving opening (6) in the area of the connecting section (4) and consisting of a material that is substantially transparent to laser beams.

### CROSS REFERENCE TO RELATED APPLICATION

This application claims priority to International Application No. PCT/EP2008/054853, filed Apr. 22, 2008, which is based on and claims priority to German Patent Application No. 20 2007 006 954.5, filed May 11, 2007.

### FIELD OF THE INVENTION

The present invention relates to a connecting device for fluid, in particular hydraulic fluid mediums, consisting of a plastic connecting element having at least one connecting section with a receiving opening for a tubular conduit end to be laser-welded.

### BACKGROUND OF THE INVENTION

DE 10 2006 034 697 A1 describes a plastic conduit having a connecting element, in the form of a hydraulic elbow plug or a plastic housing of another hydraulic element, welded directly onto a conduit end. For laser welding, the plastic conduit and/or the connecting element should consist of a plastic that is transparent to laser beams, and all the components (connecting element and conduit) should be made of the same plastic material. The laser-transparent configuration does, however, exclude certain applications because particular plastic ingredients such as reinforcers (for example glass/carbon fibers) and additives (for example color pigments and in particular carbon black as UV protection) cannot be used owing to the required laser transparency, or can be used only to a limited extent, because such ingredients would affect the laser transparency so that the material would be less laser-transparent or no longer laser-transparent at all.

It is an object of the present invention to provide a connecting device of the type described, with which it is possible to configure the connecting element for virtually any desired applications while retaining the possibility of a welded connection by means of laser welding.

### SUMMARY OF THE INVENTION

A connecting element according to the invention consists of at least two components with different material properties, a first component surrounding the receiving opening in the area of the connecting section and consisting of a material that is substantially transparent to laser beams. In the remaining area of the connecting element, the other, second component may be configured in respect of its material properties for virtually any desired application-specific requirements, and in particular irrespective of its properties with respect to laser beams. This means that the second component may in particular be designed to be laser-absorbent (not laser-transparent). The second component may therefore contain any desired application-specific material ingredients, in particular any desired reinforcers (for example glass/carbon fibers) and/or particular additives, for example property-modifying additives.

Other configurational features, particular embodiments and achieved advantages will also be explained in the following description.

### BRIEF DESCRIPTION OF THE DRAWINGS

The invention will be described in more detail with the aid of several exemplary embodiments of a connecting device.

FIG. 1 shows a connecting device according to the invention in a longitudinal section of the connecting element, designed for example as an elbow plug, having a connected conduit end,

FIGS. 2 to 5 respectively show the area X of FIG. 1 in possible alternative embodiments,

FIG. 6 shows an axial section through the area of the conduit receiving opening with a connected conduit end in another embodiment,

FIG. 7 shows another alternative embodiment in a view similar to FIG. 6, but with a conduit end not yet connected,

FIGS. 8 to 10 show representations similar to FIG. 6 in other alternative embodiments.

In the various figures of the drawing, parts which are the same are always provided with the same references.

### DETAILED DESCRIPTION OF THE INVENTION

According to FIG. 1, a connecting device 1 according to the invention consists of a plastic connecting element 2. The connecting element 2 comprises at least one connecting section 4 having a receiving opening 6 for a tubular conduit end 8 to be laser-welded. The conduit end 8 may, as represented, be an end section of a plastic pipe conduit or hose conduit, or a component of any other connecting element or equipment part, in which case the connecting element 2 will be arranged (or fastened or formed) for example on the end of a pipe conduit or hose conduit. The conduit, or the conduit end 8, may be designed circularly in cross section or non-circularly, for example ovally or polygonally.

According to the invention, the connecting element 2 consists of at least two components K1, K2 with different material properties. A first component K1 surrounds the receiving opening 6 in the area of the connecting section 4 and consists of a material that is substantially transparent to laser beams. The other, second component K2 may consist of a material that absorbs laser beams, and which can therefore contain any desired material ingredients selected according to the application-specific requirements. The second component K2 preferably consists of a polyamide, in which case this base plastic may for example comprise particular material ingredients or additives, mentioned in brackets, for the following application-specific requirements:
mechanical strength (reinforcers, in particular inorganic and/or organic materials on such as glass, carbon and/or flax fibers, glass beads, mica platelets), the additives being selected according to the following required parameters: strength (tension), pressure resistance (bursting pressures), ductility, stiffness, elasticity (for example under stone impact), hardness
UV protection (using for example carbon black, pigments, nano-pigments)
thermal stability (using for example carbon black)
electrical and/or thermal conductivity (using for example carbon black, metal particles)
antistatic configuration (using for example carbon black, particle pigments)
chemical stability (using for example carbon black, pigments, coatings) in particular for conveying fuels, oils and the like
reduction of inflammability (using for example bromine, phosphorus compounds)

With respect to the laser-transparent component K1, the wall thickness should also be taken into account because the laser transmission decreases according to an e function when shining through component K1. R+A+T=100% applies here, R denoting the reflectivity, A the absorption and T the transmission. The configuration should in every case be carried out so that R is less than 20%. The radially measured wall thickness of the laser-transparent component K1 should preferably lie in the range of from 1 mm to 5 mm. In the case of fiber reinforcement fillers, the proportion of fibers should be at most about 30%, and more specifically as a function of the material thickness to be shone through by laser light (for example about 30% for 1 mm and at most 10% down to 0% for 5 mm). Conversely, the second component K2 may contain any desired fiber proportions of from for example 20% to 60%.

In the preferred embodiment illustrated in FIG. 1, the second component K2 next to the laser-transparent first component K1 is designed as a plug-in connecting element having (at least) one plug shaft 10, and specifically for example in the form of an elbow plug as represented in FIG. 1. As an alternative or else in addition to the plug shaft 10, at least one plug collar may be provided for inserting a plug shaft of another connecting element. A design as a T piece, straight through-connector, distributor or any desired elbow piece is also possible.

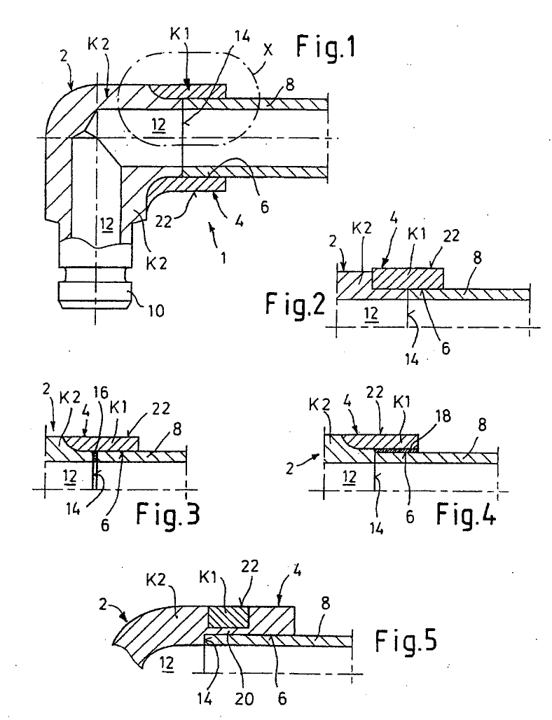

In an advantageous configuration, an inner media channel 12 of the connecting element 2 is fully surrounded by the material of the second component K2 over the entire length of its extent, except for an inner insertion-side end area of the receiving opening 6 for the conduit end 8. In the embodiments according to FIGS. 1 to 5, the inner end of the receiving opening 6 is formed by a radial bearing step 14, on which the inserted conduit end 8 comes to bear. In this way, the inner media channel 12 merges directly into the conduit end 8 so that the media channel 12 is also fully surrounded in this area on the one hand by the material of the second component K2 and on the other hand by the material of the conduit end 8. The connecting device 1 is therefore also suitable for mediums which must for example be protected against external UV exposure. For this purpose, the second component K2 and the conduit end 8 will be configured with appropriate material ingredients which ensure UV resistance. This will be achieved, in particular, by a black coloration.

The connecting element 2 with its components K1, K2 is preferably formed as a monobloc multicomponent shaped part (injection-molded part). This means that the components K1, K2 are homogeneously connected together with material uniformity by a material fit. As an alternative to this, the first component K1 may however also be designed as an originally separate, ring or sleeve-shaped element which will then be welded by a welding process on the one hand to the conduit end 8 and on the other hand also to the second component K2. In this case, the first component K1 overlaps the area of the terminal end of the inserted conduit end 8 axially in both directions. Production is also possible with one of the two components (in particular K1 or alternatively K2) being placed as a separately preformed part into an injection molding tool and the other component (K2 or K1) then being injected.

The welding is carried out in particular radially in the circumferential area between the conduit end 8 and the receiving opening 6. As an alternative or in addition, axial welding may also be carried out in the area of the bearing step 14 and the terminal end, of the conduit end 8, bearing on it. According to FIG. 3, to this end it may be expedient to arrange a plastic layer 16, which consists of a laser-meltable material, in this area i.e. axially between the conduit end 8 and the bearing step 14. According to FIG. 4, such a plastic layer 18 may in principle also be arranged radially between the receiving opening 6 and the conduit end 8. The embodiments according to FIGS. 3 and 4 may also be combined with one another, i.e. both layers 16 and 18 may be provided simultaneously. The plastic layers 16, 18 may be designed as a sheet, sleeve, coating, printing or vapor deposition.

In the embodiment according to FIG. 5, an e.g. hollow cylindrical section of the second component K2 is additionally arranged radially between the first component K1 and the receiving opening 6. This section forms a melting zone 20 for the purpose of welding to the conduit end 8.

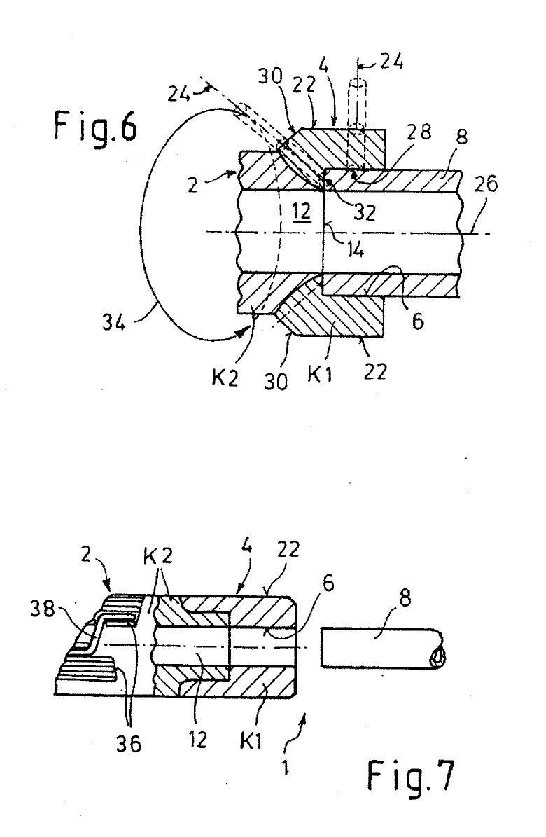

For welding by the laser-welding method, it is advantageous for the first component K1 to comprise an approximately cylindrical outer surface 22 in an area axially overlapping at least the receiving opening 6. As illustrated in FIG. 6, a laser beam 24 can therefore be aligned perpendicularly to the longitudinal axis 26 of the receiving opening 6, or of the connecting section 4, and therefore radially and also perpendicularly to the outer surface 22. This will achieve minimal reflection so that a maximal fraction of the laser beam is allowed to penetrate into the welding zone 28 radially between the receiving opening 6 and the conduit end 8.

As is furthermore represented in FIG. 6, as an alternative or in addition it may be advantageous for the first component K1 to comprise a conical surface 30 such that a laser beam 24, aligned obliquely to the longitudinal axis 26 and striking the conical surface 30 perpendicularly, penetrates through the first component K1 into a welding zone 32 which lies axially between the bearing step 14, in this case formed by the first component K1, and the front terminal end of the conduit end 8. In this way, the conduit end 8 can also be welded axially.

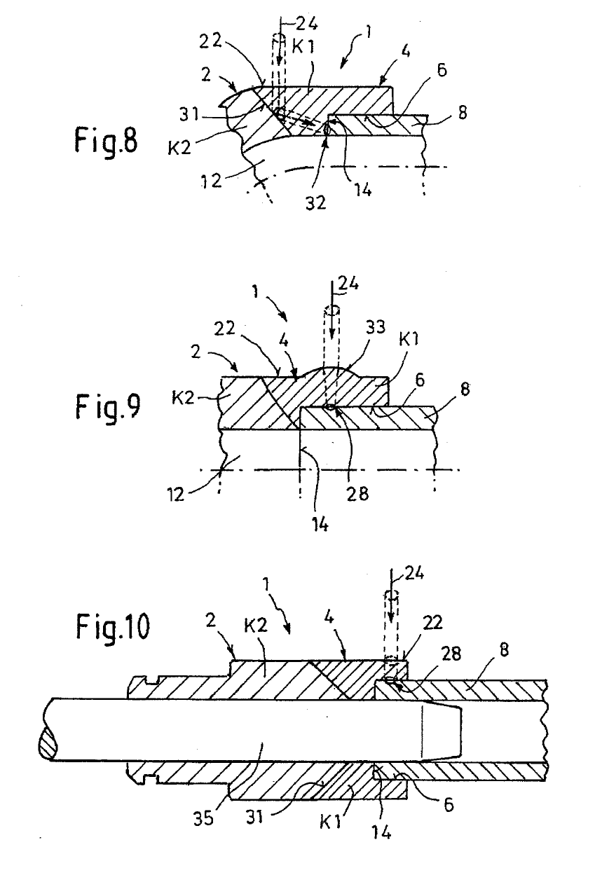

In this regard, FIG. 8 represents an alternative embodiment in which the two components K1 and K2 are connected via for example conical interfaces 31 so that the laser beam 24, initially shone radially into the outer surface 22 of the first component K1, is directed by reflections from the interfaces 31 into the area of the axial welding zone 32.

The outer surface 22, or the conical surface 30, is designed “relatively smoothly” i.e. with minimal roughness as is conventional or achievable for injection-molded parts.

In principle, under certain circumstances the laser beam 24 may also be aligned obliquely toward the respective surface 22 or 30. It is furthermore possible to configure the respective surface in such a way, in particular curved convexly as seen in radial and/or axial section, so as to achieve a lens effect in order to concentrate the laser beams. In this regard reference is made to the embodiment in FIG. 9, according to which a bead 33, extending fully around the welding area in the circumferential direction, is formed on the outer surface 22 so that the laser beam 24 strikes a curvature, which is convex in axial section, of the laser-transparent component K1 and is therefore focused (concentrated) into the welding zone 28. This will advantageously avoid overheating of the outer surface 22; the heat will be concentrated onto the welding zone.

According to FIG. 6, the laser beam 24 is respectively moved around the longitudinal axis 26 during the welding process (cf. arrow 34) in order to weld the conduit end 8 tightly over its entire circumference.

In this context, it is important to configure the receiving opening 6 in respect of its inner cross section in a match with the outer cross section of the conduit end 8, so that the conduit end 8 can be radially inserted without play with a junction fit or press fit. In this way, besides mechanical strength, a high-quality welded connection will be achieved in respect of tightness.

In this regard, FIG. 10 illustrates that a supporting rod 35 can be inserted internally, in particular through the connecting element 2, into the region of the welding zone 28 for the duration of the welding process, the supporting rod 35 firmly pressing the conduit end 8 radially from the inside into the component K1, in particular owing to a slightly larger diameter. This also contributes to a high quality of the welded connection. In the case of an elbow connector (cf. FIG. 1), the supporting rod 35 may be designed flexibly (bendably) so that it can be inserted through the connecting element 2, for which purpose the media channel 12 must naturally be designed continuously, even in the angled area, with the same inner cross section (in the shape of an arc).

As is further revealed by FIG. 7, the connecting element 2 may comprise any desired surface in that area of the component K2 which lies outside the connecting section 4, and in particular projections 36 to hold heating wires 38 of an electrical heating apparatus. This configuration is advantageous in particular for an application in which a medium at risk of freezing is intended to be conveyed through the connecting element 2, or its media channel 12, as is the case for example with water conduits for windshield washers in motor vehicles and with conduits for a urea solution, which is used as an NOₓ reduction additive for diesel motors with so-called SCR catalysts.

In another advantageous configuration of the invention, the components K1 and K2 are designed so that they differ from one another in their external appearance. This may for example be achieved by a different reflectivity for the visible light spectrum, in particular by different colors. The welding zone to which the laser beam is intended to be supplied is therefore characterized by the first component K1. The component K1 therefore also serves as an indicator for the welding zone. It furthermore characterizes the type of connecting element 2 in relation to other types of connecting elements, for example connecting elements injection-molded on.

The invention leads to the substantial advantage that by far the majority of the connecting element 2, namely the second component K2, can be composed freely in respect of its material composition and may contain any desired reinforcers and/or additives. Thus, for example, a high glass fiber proportion of for example from 30% to 50% is possible for a high mechanical strength. Nevertheless, the laser-transparent component K1 allows optimal welding by the laser-welding method.

The invention is not restricted to the exemplary embodiments which have been represented and described, but also comprises all embodiments with equivalent effect in the scope of the invention. Furthermore, the invention is thus far also not restricted to the feature combination defined in the claims, but may also be defined by any other desired combination of particular features among all the individual features disclosed in total.

1. A connecting device for fluid mediums, including hydraulic fluid mediums, of the type having a plastic connecting element having at least one connecting section with a receiving opening for a tubular conduit end to be laser-welded, comprising the connecting element formed of at least a first and a second component with different material properties, the first component surrounding the receiving opening in the area of the connecting section and consisting of a material that is substantially transparent to laser beams.

2. The connecting device as claimed in claim 1, comprising the component, formed such that the conduit end can be welded radially or axially.

3. The connecting device as claimed in claim 1, comprising that the a second component is designed as a plug-in connecting element having at least one plug shaft or at least one plug collar.

4. The connecting device as claimed in claim 1 comprising that an inner media channel of the connecting element is fully surrounded by the material of the second component over the entire length of its extent except for an inner insertion-side end area of the receiving opening for the conduit end.

5. The connecting device as claimed in claim 1 comprising that the connecting element with its first and second components is are formed as a monobloc multicomponent shaped part.

6. The connecting device as claimed in claim 1 further comprising a laser-meltable plastic layer for axial or radial welded connection of the conduit end provided inside the receiving opening.

7. The connecting device as claimed in claim 1 comprising that the first component comprises an approximately cylindrical outer surface in an area axially overlapping at least the receiving opening.

8. The connecting device as claimed in claim 1 comprising that the first component comprises a conical surface such that a laser beam, aligned obliquely to the longitudinal axis and striking the conical surface perpendicularly, penetrates through the first component into the area of a bearing step which surrounds the receiving opening.

9. The connecting device as claimed in claim 1 comprising that the components differ from one another in their external appearance.

10. The connecting device as claimed in claim 1 comprising that the first component is externally designed in the manner of a lens, so that an incident laser beam is concentrated in the direction of a welding zone.

11. The connecting device as claimed in claim 1 comprising that the two components are connected via conical interfaces, so that a laser beam can be deviated by reflection from the interfaces.
